(19) United States
(12) Patent Application Publication
(10) Pub. No.: US 2022/0368096 A1
(43) Pub. Date: Nov. 17, 2022

(54) DEVICE, METHOD AND SYSTEM FOR ASSEMBLY OF AN ELECTRICAL PLUG CONNECTOR

(71) Applicant: Metzner Holding GmbH, Ulm (DE)

(72) Inventors: Manfred SORG, Ulm (DE); Pascal MAIER, Ulm (DE)

(21) Appl. No.: 17/773,074

(22) PCT Filed: Nov. 5, 2020
(86) PCT No.: PCT/EP2020/081066

§ 371 Date: Apr. 29, 2022

(30) Foreign Application Priority Data
Nov. 11, 2019 (DE) 10 2019 130 288.9

(51) Int. Cl. H01R 43/20

(52) U.S. Cl. CPC H01R 43/20

(57) ABSTRACT

The invention relates to a device (1) for the assembly of an electrical plug connector (2). The device has a feed incl (16) cf that is designed to press a forward end (5) of an electdc cable (3a, 3b), said forward end being prefabricated with an inner conductor contact element (6), into a corresponding plug-in point (17) of a housing assembly (4) of the ping connector (2) along a feed direction (X) until the lamer conductor contact element (6) reaches a larger position (Ps) within the housing assembly (4). The device (1) also has an optical sensor unit (24), which is designed to detect the actual position (Pl) of the inner conductor contact element (6) within the housing assembly (4) while the cable (3a, 3b) is being pressed in. The device (1) further has a force transducer (23), which is designed to detect the pressing force applied while the cable (3a, 3b) is being pressed in.

The invention relates to a device for assembly of an electrical plug connector, the device having a feed unit for pressing a front end of an electric cable, said front end being prefabricated with an inner conductor contact element, into a corresponding plug-in point of a housing assembly of the plug connector.

The invention also relates to a method for assembling an electrical plug connector, according to which a front end of an electric cable, said front end being prefabricated with an inner conductor contact element, is pressed by a feed unit in a feed direction into a corresponding plug-in point of a housing assembly of the plug connector, until the inner conductor contact element has reached a target position within the housing assembly.

The invention additionally relates to a computer program product having program code means and to a system for assembling an electrical plug connector.

When fabricating cables, their conductors are typically connected to a plug connector in order to subsequently be able to establish electrical connections to other cables or conductors which have corresponding plug connectors or mating plug connectors. A plug connector or mating plug connector can be a plug, a panel connector, a socket, a coupling or an adapter. The term “plug connector” or “mating plug connector” used within the scope of the invention is representative for all variants.

High requirements are placed on the robustness and safety of the plug connections in particular for plug connectors for the automotive industry or for vehicles. The automotive industry and suppliers thereto face large challenges in particular in respect of electromobility, since high currents with voltages up to 1500V are sometimes transferred into the vehicles via the cables or lines. With the risk that would result from a failure of components in an electric vehicle, particularly high requirements must therefore be placed on the quality of the cable or lines and plug connections.

A plug connection must therefore sometimes withstand high loads, for example mechanical loads, and remain definably closed, so that the electrical connection is not unintentionally separated, for example during operation of a vehicle.

A further requirement of plug connectors for the automotive industry lies in the fact that they must be producible economically in high quantities. Fully automated cable fabrication to the greatest extent possible is for this reason preferred, in particular for fabrication of cables for the automotive industry. Corresponding production lines must therefore be established in order to achieve the required quantities while simultaneously providing high quality.

In particular if an electric cable is to be provided at one of its ends or at both ends with an electrical plug connector, it is generally necessary to slide various plug connector components onto the cable in the subsequently required order, so as to have these ready for the subsequent plug connector assembly. The components slid on previously can then be moved successively or simultaneously on the cable sheath in the direction of the front, free end of the cable, in order to be joined together with a corresponding plug connector component.

Furthermore, support sleeves, press or crimp sleeves and/or inner conductor contact elements are connected, in particular press fit, welded or soldered, to the electrical conductors of the cables. The support sleeves and press or crimp sleeves are provided here for connection to an outer conductor of the cable (in particular for assembly on an outer conductor braid), whereas the inner conductor contact elements are connected to the inner conductor or the inner conductors of the cable.

Following the pre-fabrication, the cable is then generally assembled in a housing assembly of the subsequent plug connector. Here, a plurality of cables may possibly also be assembled in one housing assembly, depending on the plug connector type. The prefabricated cables for this purpose must often be pressed with a sufficient pressing force in the corresponding plug-in points of the housing assembly.

In particular within the scope of mass production, the pressing of the prefabricated cables into a housing assembly is relatively complex. In addition, the pressing must be performed with high precision and accurate process monitoring in order to ensure a high-quality and robust plug connector.

In view of the known prior art, the object of the present invention lies in providing a device for assembly of an electrical plug connector, which device is advantageously suitable in particular within the scope of an automated cable fabrication process.

A further object of the present invention is to provide a method for assembling an electrical plug connector, which method is advantageously suitable in particular within the scope of an automated cable fabrication process.

Lastly, a further object of the invention is to provide a suitable computer program product and an advantageous system for assembly of an electrical plug connector.

The object is achieved for the device by the features described in claim 1. In view of the method, the object is achieved by the features of claim 9. With regard to the computer program product, the object is achieved by the features of claim 20, and in relation to the system by claim 21.

The dependent claims and the features described hereinafter relate to advantageous embodiments and variants of the invention.

A device for assembly of an electrical plug connector is provided, the device having a feed unit which is designed to press a front end of an electric cable, said front end being prefabricated with an inner conductor contact element, in a feed direction into a corresponding plug-in point of a housing assembly of a plug connector, until the inner conductor contact element has reached a target position within the housing assembly.

The inner conductor contact element is preferably press fit, welded and/or soldered to an inner conductor of the electric cable.

The front end of the cable preferably has a support sleeve and/or a press or crimp sleeve, which is press fit at the front end of the cable to an outer conductor of the cable, in particular an outer conductor braid of the cable. The cable particularly preferably has a support sleeve, which is mounted on the cable sheath of the cable and/or on the outer conductor braid, wherein the outer conductor braid is turned back towards the rear over the support sleeve and is press fit between the crimp sleeve and the support sleeve.

The support sleeve and/or press or crimp sleeve can advantageously be used to press fit the cable within the plug-in point of the housing assembly.

The target position is preferably a position of the inner conductor contact element within the housing assembly in which the inner conductor element latches with a detent means of the housing assembly and/or has assumed a plug-in position intended for the later use of the plug connector, in order to be connected to a corresponding mating plug connector.

The electrical plug connector to be assembled preferably has exactly one electric cable or exactly two electric cables. It can thus be provided to press in exactly one electric cable or to press in exactly two electric cables. In principle, however, the electrical plug connector to be assembled can also have more than two electric cables, for example three electric cables or more electric cables, four electric cables or more electric cables, five electric cables or more electric cables, six electric cables or even more electric cables.

The relevant cables can be pressed in successively or simultaneously, as will be described hereinafter in greater detail.

Where reference is made hereinafter to “the” electric cable or “an” electric cable, this is therefore not to be understood to be limiting, but is merely intended to serve for better readability. In principle, all further developments and variants of the invention described hereinafter can relate to exactly one electric cable, to exactly two electric cables or to even more electric cables, even if this is not explicitly stated. In particular, features and variants that relate to the electric cable also relate to the cable referred to hereinafter as the “second” electric cable—and vice versa.

The electric cable is preferably formed as a high-voltage line.

The electrical plug connector is preferably formed as a high-voltage plug connector.

The electric cable and/or the electrical plug connector can be considered within the scope of the invention to be part of the device. The electric cable and/or the electrical plug connector, however, can also possibly be independent of the device.

In principle, within the scope of the invention, any electric cable can be assembled in any plug connector or pressed into any housing assembly. However, the electric cable preferably has exactly one outer conductor or is formed as a shielded electric cable. The invention is particularly advantageously suitable for processing electric cables that have a large cross section for a high current transfer, for example in the automotive sector, particularly preferably in the field of electromobility. An electric cable for the high-voltage range can thus be provided, in particular a high-voltage line.

The electric cable can have any number of inner conductors, but preferably just one single inner conductor. However, two inner conductors or more inner conductors, three inner conductors or more inner conductors, four inner conductors or even more inner conductors can also be provided. If the cable has a plurality of inner conductors, these are prefabricated with respective inner conductor contact elements. The inner conductor contact elements can then be inserted in each case into their own plug-in point or into one or more common plug-in points in the housing assembly, when the front end of the cable is pressed into the housing assembly.

The electric cable is particularly preferably formed as a coaxial cable with exactly one inner conductor and exactly one outer conductor.

The “front end” of the cable can be a cable endpiece, which preferably comprises at least the inner conductor contact element and one or more support sleeves or press sleeves or crimp sleeves.

In particular, the invention can be intended for an automated or fully automated assembly of the electrical plug connector.

In accordance with the invention, the device has an optical sensor unit, which is designed to detect the actual position of the inner conductor contact element within the housing assembly while the cable is being pressed in.

The optical sensor unit is preferably formed as a camera, in particular a high-speed camera, and/or as a light band or light barrier.

The optical sensor unit can be designed to detect the actual position of the inner conductor contact element continuously or in rapid sequence. For example, 20 to 50 evaluations per second, preferably 50 to 200 evaluations per second, particularly 200 to 400 evaluations per second, very particularly preferably 400 to 600 evaluations per second, even more preferably 600 to 1000 evaluations per second, for example 800 evaluations per second, or even more than 1000 evaluations per second can be provided.

Since the optical sensor unit monitors the actual position of the inner conductor contact element while the cable is being pressed in along the feed direction, a high precision of the assembly of the plug connector can be ensured. In particular, the inner conductor contact element can be positioned with high accuracy within the housing assembly.

In accordance with the invention, a force transducer is additionally provided for detecting the pressing force applied as the cable is being pressed in.

The force transducer can be integrated, for example, in the feed unit.

Due to the monitoring of the pressing force, the assembly process of the plug connector can be advantageously monitored and thus can be made particularly reliable.

In particular, a monitoring of the pressing force and a comparison with the actual position detected simultaneously by the optical sensor unit can be advantageous in order to check the assembly process. For example, the pressing force can thus be detected and evaluated depending on the actual position of the inner conductor contact element.

In an advantageous further development of the invention, it can be provided that the feed unit has a holding unit for fixing the cable while the cable is being pressed in. The holding unit can preferably have at least one clamping jaw which can be moved towards a cable sheath of the cable.

The holding unit is movable by the feed unit, preferably together with the cable fixed therein, in the feed direction in order to press the front end of the cable into the plug-in point of the housing assembly.

The holding device preferably has exactly one clamping jaw or exactly two clamping jaws, which can be moved in the direction of the center axis of the cable in order to fix the cable at its cable sheath.

If exactly one movable clamping jaw is provided, this can press the cable, for fixing of the latter, against a support arranged opposite the clamping jaw along the cable sheath.

The holding device preferably fixes the cable such that the latter cannot rotate.

The device can have a transport unit in order to move the cable into the feed unit, in particular into the holding unit. The transport unit can have, for example, driveable transport rolls in order to guide the cable tangentially between said rolls. The transport unit can also have a belt conveyor unit or one or more gripper units. The transport unit can perform a first movement of the cable along the feed direction, after which the feed unit performs the further transport and pressing-in of the cable.

In accordance with a further development of the invention, it can be provided that the device has a control unit for monitoring the assembly, in particular for assessing the detected actual position and the detected pressing force within the scope of a quality control.

In particular, the control unit can be designed to compare the detected pressing force with a specification for the pressing force and to classify the plug connector accordingly. The plug connector can be marked or characterized in accordance with the classification. The plug connector can be divided into different quality classes in accordance with the classification and also removed from the production process if necessary.

The control unit can also be formed in particular in order to prompt the feed unit to stop the pressing-in of the cable or the feed of the cable as soon as the actual position detected by the optical sensor unit corresponds to the provided target position. The control unit can control the feed of the cable, possibly also according to the actual position and/or the detected pressing force, for example can slow the feed of the cable as the actual position approaches the target position.

The control unit can be designed to control and/or to monitor the assembly process in part or in full. The control unit can be designed to guide the responsible production workers through the processing process and to provide the workers for example with instructions where manual intervention is required or in the event of a fault, for example by way of visual and/or acoustic prompts.

In accordance with an embodiment of the invention, it can be provided that individual or all processing tools of the device, in particular processing tools that are exchangeable according to the cable geometry/cable type or the plug connector geometry/plug connector type, have an identifier, for example a barcode, a QR code or an RFID transponder. In this way, the processing tools can be identified by readers arranged in a distributed manner accordingly in the device (preferably monitored by the control unit), in particular in order to determine whether the correct processing tools are being used for the provided assembly process and/or whether the processing tools are actually present at their particular destination or are being used correctly.

It can also be provided that the cable and/or the plug connector components have a corresponding identifier, for example a barcode, a QR code or an RFID transponder. In this way, it can be ensured that the correct cable types and/or plug connector components are used for the provided assembly process.

For example, the responsible production worker can identify the cable and/or the plug connector components by means of an accessible or mobile reader prior to the placing or during the placing in the device. The control unit, for example, can in this case display to the user (inter alia visually and/or acoustically) whether and for which plug-in point of the housing assembly the cable is intended. Alternatively, the identification can also be performed in fully automated fashion when the reader is positioned according in the device.

In accordance with a further development of the invention it can be provided that the device has a fixing unit for fixing the housing assembly in an assembly position along the feed direction.

The fixing unit can be movable in particular towards the housing assembly. The housing assembly can hereby be placed in the device before the cable or cables is/are pressed in and can be removed from the device again once the cable or cables has/have been pressed in.

The fixing unit can have one or more pressing jaws.

The fixing unit can have a locking mechanism, preferably at least one locking pin, in order to fix the fixing unit in the position moved towards the housing assembly. Two locking pins introducible into the fixing device from either side are preferably provided. The locking pins are preferably moved in fully automated fashion.

To ensure a high level of protection against tampering during assembly of the plug connector, it can be provided that the locking mechanism of the fixing unit can be unlocked at an unscheduled time only by a special release authorization.

In an embodiment of the invention, the plug connector assembly process can be documented within the scope of a quality control.

Within the scope of the quality control, it can additionally be provided to reject so called “bad parts”, i.e., plug connectors assembled incorrectly or with insufficient quality. In order to ensure a rejection of the bad parts in any case, it is known to mark the bad part discernibly or to destroy it. In particular, it is known to cut the cable into pieces. This process indeed allows a high level of protection against tampering, but at the same time introduces particles (for example cutting residues, film residues, etc.) into the device, which in turn should be avoided in order to ensure a high level of quality of the plug connector assembly process. For this reason, it can be provided to fix the housing assemblies of bad parts initially in the device in a manner secured against removal by the locking mechanism of the fixing unit and to interrupt the processing until the bad part, by way of a special release authorization, has been removed from the device.

In a further development of the invention it can be provided that the device has an alignment aid with a receptacle and/or with a stop for the front end of the cable. The alignment aid can be designed to correctly align the cable at a starting position along the feed direction before being pressed in.

The alignment aid can additionally be designed to be removed from the displacement path of the cable, in particular orthogonally to the feed direction, following the alignment of the cable.

The receptacle or the stop of the alignment aid can in particular can be fork-shaped. The alignment aid can thus be removed advantageously in a rectilinear movement laterally or orthogonally to the feed direction.

In a further development of the invention it can be provided that the device has a checking unit which is designed to check for correct pre-processing of the cable while the cable is being placed in the device and/or while the cable is being pressed into the housing assembly.

In particular it can be provided to check, by means of the checking unit, a correct pre-equipping of the cable sheath of the cable with plug connector components (for example of a line seal).

The plug connector components can be any components of the electrical plug connector to be assembled on the corresponding cable end which preferably have respective through-bores for receiving the cable. The plug connector components can thus be slidable onto the electric cable, in particular onto the cable sheath of the cable, prior to the pressing-in, in particular also prior to the assembly of a support sleeve, a press sleeve or crimp sleeve or the inner conductor contact element. The diameter of the through-bores can correspond here substantially to the diameter of the electric cable or cable sheath thereof. However, the diameter of the through-bore can also be larger or slightly smaller than the diameter of the electric cable or cable sheath thereof, in order to be able to influence mechanical play of a plug connector component slid onto the cable.

In principle, the electric cable within the scope of the invention can be equipped with any plug connector components. For example, it can be provided that at least one of the plug connector components is a support sleeve, a line seal, a cable holding means, a holding cap or an angled cap.

The line seal can be, in particular, a mechanical seal, for example a ring seal for sealing against dirt, dust, liquids or gases, which for example can be pushed into the housing assembly from behind. The diameter of the through-bore of the line seal can preferably be slightly smaller than the diameter of the cable sheath, in order to improve the tightness. The line seal can have any cross-sectional geometry. Circular line seals are frequently used. However, oval or polygonal, in particular rectangular, for example also square line seals can also be provided. There is generally no need for a specific orientation for the assembly of the line seal, in particular in the case of lines seals that have a circular cross-sectional geometry. If an oval or polygonal (for example rectangular) line seal is provided, a predefined orientation relative to further plug connector components may, by contrast, be necessary, also for the line seal.

A cable holding means can be in particular a plug connector component that allows or assists a strain relief of the cable.

A closing holding cap—or in the case of an angled plug connector, an angled cap—can be a plug connector component closing the plug connector on the cable side, which for example fixes a cable holding means and/or a line seal in the plug connector, in particular in the housing assembly. It can be provided that the holding cap or angled cap has detent means in order to latch with the cable holding means and/or the housing assembly. The holding cap or angled cap can also be referred to as a termination cap assembly.

The plug connector components preferably each have only a single through-bore for receiving only a single electric cable. The plug connector components, however, can also have, for example, a number of through-bores corresponding to the number of the cables to be pressed into the housing assembly. The cables of the plug connector can thus optionally also be received in common plug connector components.

It can be provided in particular to check the presence, the correct order, the correct spacing and/or the integrity of plug connector components slid onto the cable. The check can very particularly preferably be carried out when moving the cable through the transport unit.

The integrity of the cable can also be examined on its own. For example, protruding strands of a cable braid can be identified and the cable rejected as appropriate.

For example, the checking unit can perform a visual quality check by means of optical sensors.

A camera, in particular a color camera, can preferably be provided. In particular if the plug connector components and/or the cables are color coded, for example have different colors for different cable diameters, a simple and yet highly precise identification of the correct equipping of the cable can be performed by the color camera.

The contour of the plug connector components, for example to ensure a correct equipping order and/or a correct alignment of the plug connector components can preferably be checked, separately to an optionally provided color camera, by one or more separate optical sensors.

A cable not correctly processed or equipped can be rejected for example from the subsequent assembly process, labelled or marked as defective and/or reprocessed.

In an advantageous further development of the invention it can be provided that the device has a prestressing unit which is designed to mechanically pre-stress a detent means, provided for latching the inner conductor contact element, within the housing assembly orthogonally to the feed direction.

The introduction of the inner conductor contact element into the housing assembly can hereby be simplified.

The prestressing unit preferably has a telescopic ram movable orthogonally to the feed direction. The telescopic ram can be introduced into a plug-in region of the housing assembly intended for connection of the plug connector to a mating plug connector, in order to pre-stress the detent means.

The prestressing unit, in particular a front end of the telescopic ram, can have a tactile element, a proximity sensor or an electrical contact in order to identify contact of the inner conductor contact element or an imminent collision of the inner conductor contact element with the prestressing unit or the telescopic ram. In the event of an identified collision or an imminent collision, the prestressing unit, in particular the telescopic ram, can ultimately be removed from the displacement path of the inner conductor contact element.

In a further development of the invention, it can be provided that the feed unit is designed to press a front end of a second electric cable, said front end being prefabricated with an inner conductor contact element, in the feed direction into a corresponding second plug-in point of the housing assembly.

This preferably occurs once the first cable has been pressed into its target position.

However, it can also be provided that a second feed unit presses in the second cable while the first cable is being pressed in or once the first cable has been pressed in.

It can also be provided that two feed units are provided with a common drive, wherein the drive firstly drives the first feed unit in order to press in the first cable and then drives the second feed unit in order to press in the second cable.

In an embodiment of the invention, an actuation unit for actuating a secondary safeguard of the housing assembly can be provided, for example a secondary safeguard arranged centrally within the housing assembly. The actuation device can have an actuation ram in order to actuate the secondary safeguard.

It can be provided that the control unit monitors the actuation of the secondary safeguard and for example protects (for example by monitoring the displacement path and/or the forces occurring during the actuation) whether the secondary safeguard has been correctly actuated or not. In this way, it can be detected in particular whether the secondary safeguard is actually present in the housing assembly and/or whether the assembly has been performed correctly, since the secondary safeguard otherwise generally would not be able to be brought into its safeguarding position.

The invention also relates to a method for assembling an electrical plug connector. It is provided that a front end of an electric cable, said front end being prefabricated with an inner conductor contact element, is pressed by a feed unit in a feed direction into a corresponding plug-in point of a housing assembly of a plug connector until the inner conductor contact element has reached a target position within the housing assembly. While the cable is being pressed in, an optical sensor unit detects the actual position of the inner conductor contact element within the housing assembly. A force transducer detects the pressing force applied while the cable is being pressed in.

It can be provided that the method described above and hereinafter is performed with use of the device already described.

In accordance with the invention a particularly accurate and reliable assembly of the plug connector can thus be provided.

In an advantageous further development of the invention, it can be provided that a correct pre-processing of the cable is checked by a checking unit prior to the cable being pressed into the housing assembly.

In particular, a correct equipping of the cable sheath with a plug connector component or with a plurality of plug connector components can be checked.

In an advantageous further development of the invention, it can be provided that the front end of the cable, prior to being pressed into the housing assembly, is firstly aligned correctly in a starting position along the feed direction by introducing the front end of the cable at least in part into a receptacle of an alignment aid and/or is contacted against a stop of the alignment aid.

A user or a transport unit of the device or a system for assembling the plug connector can thus advantageously position and/or align the cable by means of the alignment aid.

Prior to being pressed in, the cable is thus located in a known starting position and additionally is also already in a defined orientation.

In an advantageous further development of the invention, it can be provided that the alignment aid is removed from the displacement path of the cable once the front end of the cable has been correctly aligned.

The alignment aid can preferably be removed orthogonally to the feed direction in a linear movement. The alignment aid, however, can also be moved from the displacement path by way of a pivoting motion.

The alignment aid is preferably automatically moved from the displacement path.

In a further development of the invention, it can be provided that the housing assembly is fixed in an assembly position by a fixing device prior to the cable being pressed in.

The housing assembly is hereby located advantageously in a known assembly position, which can simplify the monitoring of the actual position of the inner conductor contact element.

According to a further development of the invention, it can be provided that a prestressing unit mechanically prestresses a detent means in the housing assembly orthogonally to the feed direction, said detent means being provided to latch the inner conductor contact element within the housing assembly.

The detent means can hereby be moved in particular from the displacement path of the inner conductor contact element in order to avoid a collision of the inner conductor contact element with the detent means. A collision of the inner conductor contact element with the detent means can lead to a falsified result, for example when measuring or monitoring the pressing force.

Instead of a detent means, any elastic or spring-mounted components of the housing assembly can in principle be prestressed by the prestressing unit or moved out of the displacement path of the inner conductor contact element.

In an advantageous further development, it can be provided in particular that the prestressing unit prestresses the detent means by way of the extension of a telescopic ram.

Instead of a telescopic ram, however, any means for prestressing the detent means can be provided in principle.

In an advantageous further development of the invention it can be provided that the prestressing unit, upon contact with the inner conductor contact element of the electric cable, is removed from the displacement path of the inner conductor contact element.

The prestressing unit, in particular the telescopic ram of the prestressing unit, is preferably removed from the displacement path of the cable or the inner conductor contact element as soon as the inner conductor contact element has been pushed sufficiently deeply into the housing assembly in order to prestress the detent means itself (or as soon as the inner conductor contact element has been moved at least partly over the detent means. Pressing the cable in further can ultimately cause the detent means to latch into a corresponding receptacle in the inner conductor contact element and relax again at the same time.

In accordance with a further development of the invention, it can be provided that the feed unit stops the feed of the cable as soon as the actual position of the inner conductor contact element detected by the optical sensor unit corresponds to the target position.

The feed of the feed unit can be controlled depending on the actual position and/or the detected pressing force.

In an advantageous further development of the invention, it can be provided that a control unit evaluates the pressing force detected by the force transducer while the cable is being pressed in and compares this with a specification for the pressing force in order to classify the cable within the scope of a quality control.

The plug connector can be rejected in particular if the pressing force does not correspond to the specification or does not correspond sufficiently to the specification.

In an advantageous further development of the invention, it can be provided that, once the target position of the inner conductor contact element has been achieved, a front end of a second electric cable, said front end being prefabricated with an inner conductor contact element, is pressed in the feed direction into a corresponding plug-in point of the housing assembly.

However, the second cable can in principle also be pressed in simultaneously with the third cable. A sequential pressing-in of the cables can, however, be advantageous for monitoring the assembly process, in particular the pressing forces that occur.

The invention also relates to a computer program product with program code means in order to perform a method according to the details provided above and hereinafter when the program is run on a control unit of a device for assembling an electrical plug connector (in particular on a device according to the comments above and hereinafter).

The control unit can be formed as a microprocessor. Instead of a microprocessor, any further unit for implementing the control unit can also be provided, for example one or more arrangements of separate electrical component parts on a printed circuit board, a programmable logic controller (PLC), an application-specific integrated circuit (ASIC) or another programmable circuit, for example also a field programmable gate array (FPGA), a programmable logic array (PLA) and/or a commercially available computer.

The invention also relates to a system for assembly of an electrical plug connector. The system comprises a device for assembly of the electrical plug connector. The device has a feed unit which is designed to press a front end of an electric cable, said front end being prefabricated with an inner conductor contact element, in a feed direction into the corresponding plug-in point of a housing assembly of the plug connector until the inner conductor contact element has reached a target position within the housing assembly. The device additionally has an optical sensor unit, which is designed to detect the actual position of the inner conductor contact element within the housing assembly while the cable is being pressed in. The device also has a force transducer for detecting the pressing force applied while the cable is being pressed in. The system additionally comprises at least one processing module, independent of the device, for processing the electric cable.

The distribution of the processing steps according to the invention over a plurality of processing modules independent of one another makes it possible to operate the system as an “assembly line process” or as a “clocked automated process” with successive individual steps in order to reduce the processing time for a mass manufacturing process.

Furthermore, the device or the individual processing modules can be constructed in modular fashion, whereby individual processing modules of the assembly can be replaced, modified or removed without great effort. The system can hereby be configurable for the processing of different cable types or plug connectors by simple means.

The independent processing modules can be arranged preferably upstream or downstream of the device.

In a further development of the invention, it can be provided that at least one of the independent processing modules is formed as a processing module for ensuring the correct equipping of the cable with plug connector components and/or as a processing module for trimming the length of the cable and/or as a processing module for stripping cable components of the cable and/or as a processing module for equipping the cable with one or more plug connector components.

Further processing modules independent of one another and the device can also be provided and are arranged upstream or downstream of the device.

The invention also relates to an electrical plug connector which has been assembled by a method according to the comments above and hereinafter.

The invention additionally relates to an electrical plug connector which has been assembled using a device according to the comments above and hereinafter.

Features that have been described in conjunction with the device according to the invention are of course also implementable advantageously for the method, the computer program product of the system—and vice versa. Furthermore, advantages that have already been described in conjunction with the device according to the invention can also be understood in relation to the method, the computer program product and the system—and vice versa.

It should also be noted that terms such as “comprising”, “having” or “with” do not exclude other features or steps. Furthermore, terms such as “a” or “the” that indicate any singular number of steps or features do not exclude a plurality of features or steps—and vice versa.

However, in a purist embodiment of the invention, it can also be provided that the features introduced in the invention by the terms “comprising”, “having” or “with” have been enumerated exhaustively. Accordingly, one or more enumerations of features can be considered exhaustive within the scope of the invention, for example, considered in each case for each claim. For example, the invention can consist solely of the features stated in claim 1.

Furthermore, it should be emphasized that the values and parameters described herein include deviations or fluctuations of ±10% or less, preferably ±5% or less, further preferably ±1% or less, and very particularly preferably ±0.1% or less of the particular designated value or parameter, provided that these deviations are not excluded in the implementation of the invention in practice. The specification of ranges by initial and final values also includes all those values and fractions which are included by the particular designated range, in particular the initial and final values and a corresponding mean value.

The applicant reserves the right to claim a device that comprises the features of claim 1 as an independent invention, wherein, however, feature c) of claim 1 relating to the force transducer is merely optional. The applicant further reserves the right to claim a corresponding method without the obligatory feature of the force transducer and a corresponding system without the obligatory feature of a force transducer. The further claims, claim features and the features disclosed in the description as a whole and drawings relate to advantageous embodiments and variants of the stated, independent invention.

Exemplary embodiments of the invention are described in more detail below with reference to the drawing.

The figures each show preferred exemplary embodiments in which individual features of the present invention are shown in combination with one another. Features of one exemplary embodiment can also be implemented separately from the other features of the same exemplary embodiment and can accordingly be readily combined by a person skilled in the art to form further useful combinations and sub-combinations with features of other exemplary embodiments.

In the figures, functionally identical elements are provided with the same reference signs.

In the figures:

FIG. 1 schematically shows a device according to the invention in accordance with a first exemplary embodiment while two electric cables are being introduced into respective feed units;

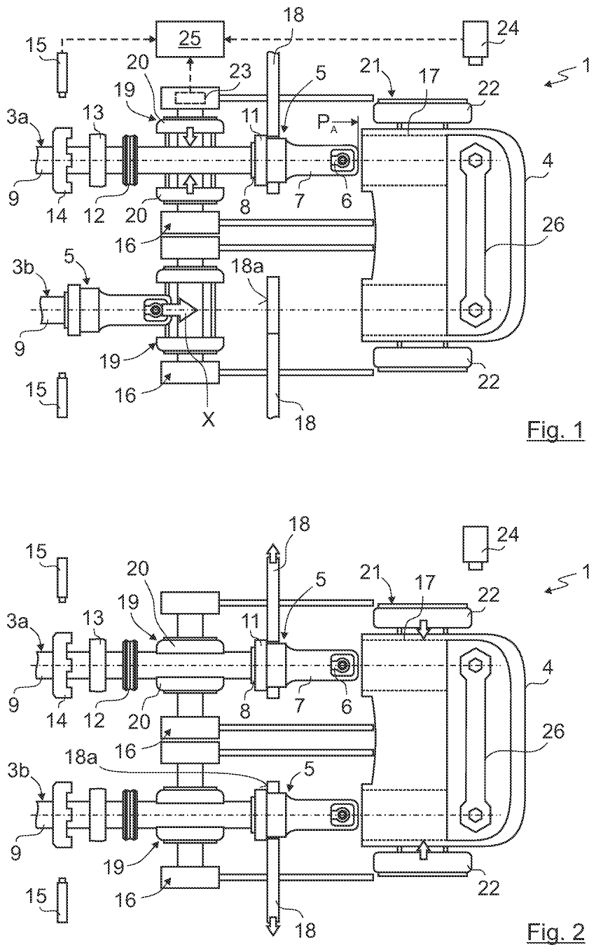

FIG. 2 schematically shows the device as per FIG. 1 once each cable has been fixed in a corresponding holding unit;

FIG. 3 schematically shows the device as per FIG. 2 once the housing assembly has been fixed by a fixing unit and while the front end of the first cable is being moved into the housing assembly by the first feed unit;

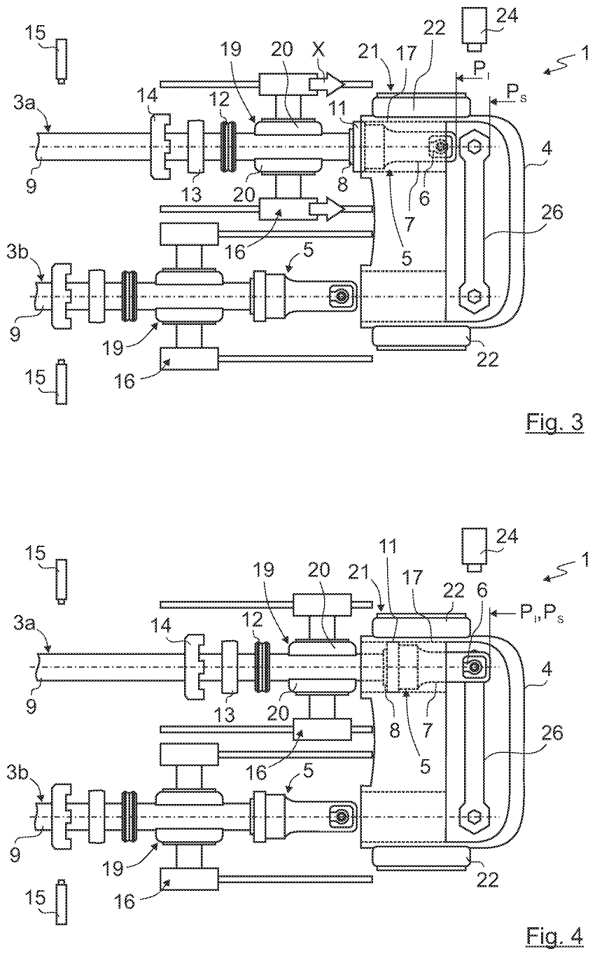

FIG. 4 schematically shows the device as per FIG. 3 once the inner conductor contact element of the first cable has reached the target position in the housing assembly;

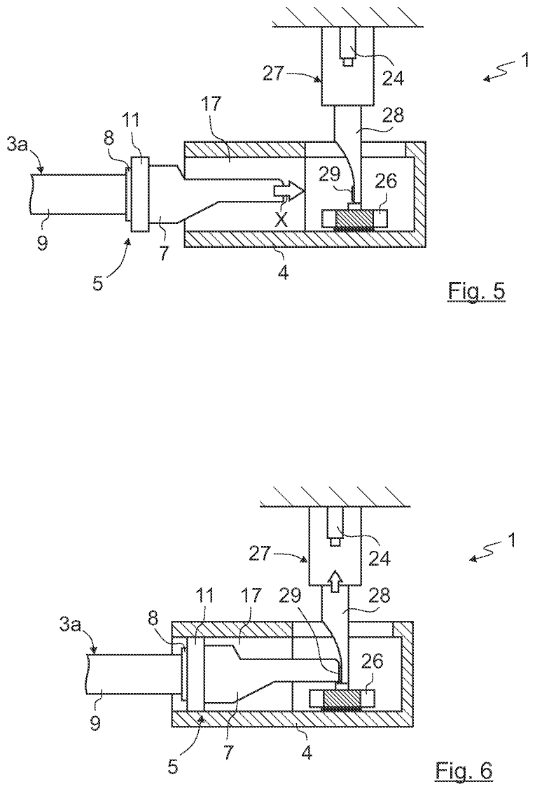

FIG. 5 schematically shows a prestressing unit with a telescopic ram for mechanically prestressing a detent means within the housing assembly;

FIG. 6 schematically shows the prestressing unit as per FIG. 6 while the inner conductor contact element, by contacting a tactile element of the telescopic ram, triggers a removal of the telescopic ram from the displacement path of the inner conductor contact element;

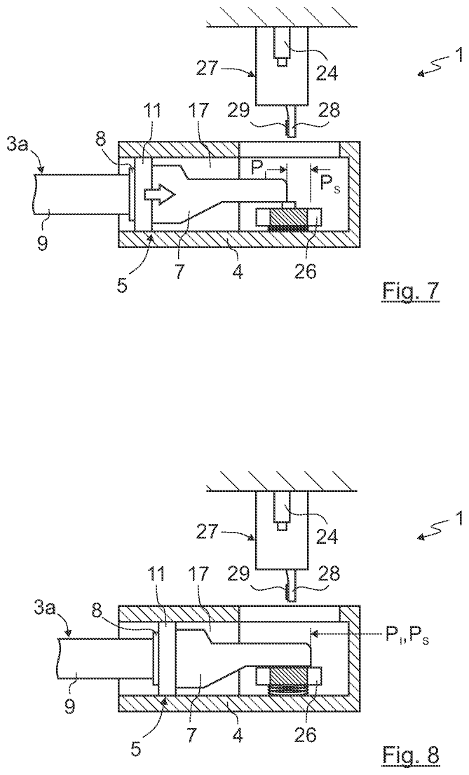

FIG. 7 schematically shows the device as per FIG. 6 while the sensor unit monitors the actual position of the inner conductor contact element within the housing assembly during the course of the front end of the cable being pressed in further;

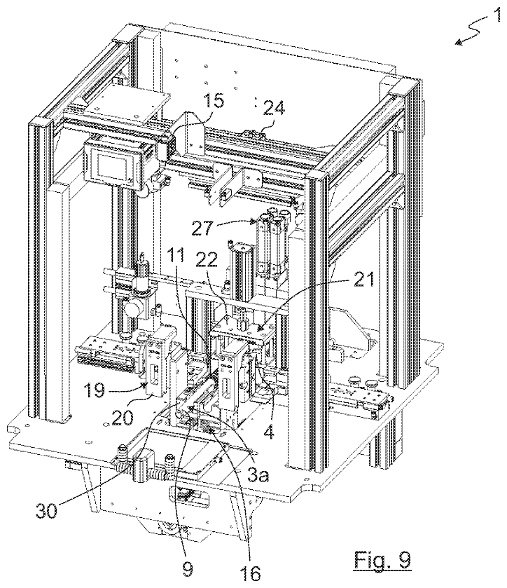

FIG. 8 schematically shows the device as per FIG. 7 once the inner contact element has reached the target position within the housing assembly;

FIG. 9 schematically shows a device according to the invention in accordance with a second, preferred exemplary embodiment while the electric cable is being introduced into the feed unit;

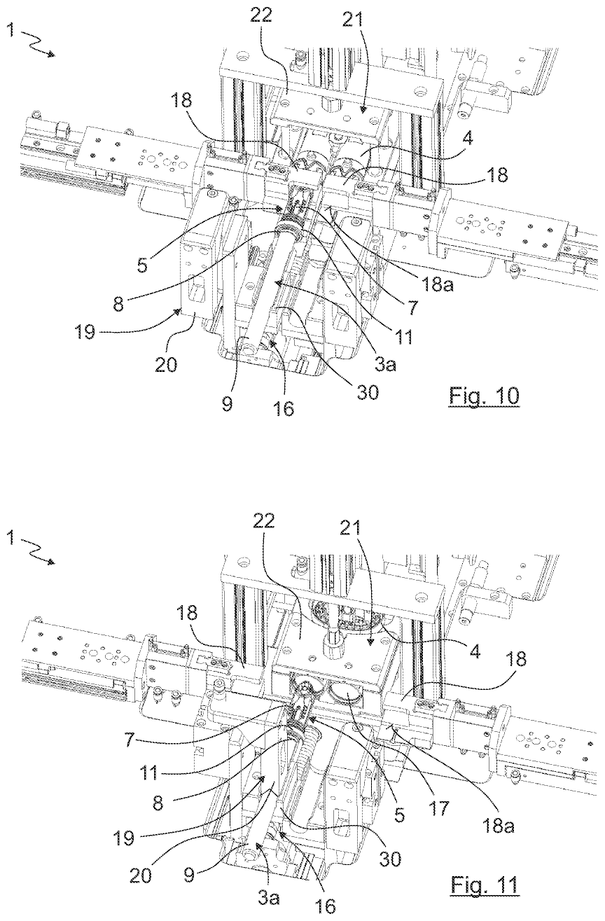

FIG. 10 schematically shows the device as per FIG. 10 following correct alignment of the cable in the starting position using the alignment aid;

FIG. 11 schematically shows the device as per FIG. 11 once the housing assembly has been fixed by the fixing unit and once the cable has been fixed in the holding unit;

FIG. 12 schematically shows the exemplary plug connector once both cables have been pressed in during the final assembly process; and

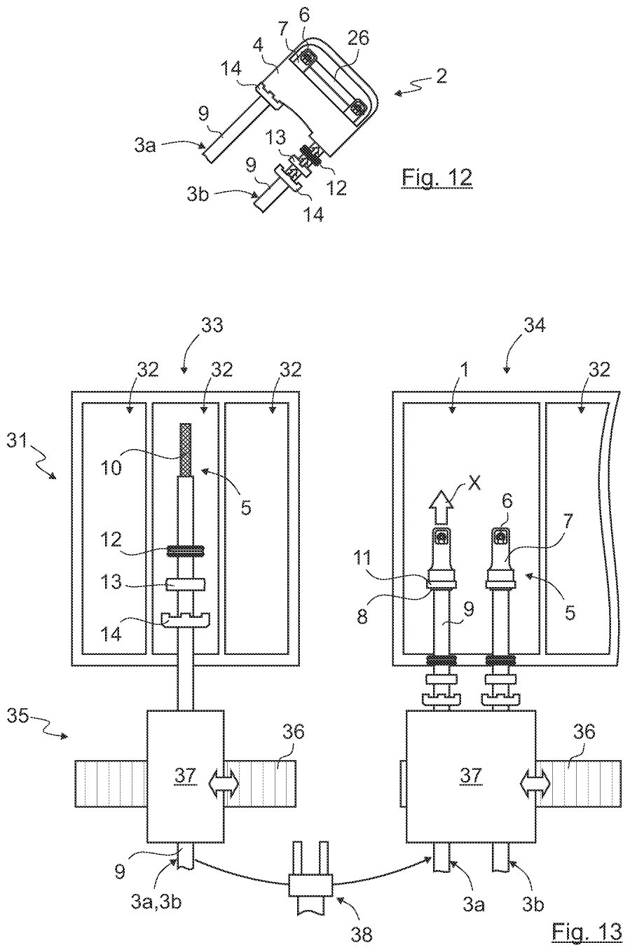

FIG. 13 schematically shows a system for assembling the electrical plug connector with a device for assembling the electrical plug connector and further processing modules independent of the device.

FIGS. 1 to 4 show a device 1 according to the invention for assembly of an electrical plug connector 2 (see FIG. 12) during various assembly steps. All illustrations are to be understood to be exemplary and heavily schematized and are only intended for the purpose of explaining the invention.

FIG. 1 shows a state of the device 1 while prefabricated electric cables 3a, 3b, which are to be assembled subsequently in a housing assembly 4 of the plug connector 2, are being placed in position. Merely by way of example, the invention will be described on the basis of a plug connector 2 which can receive two electric cables 3a, 3b. In principle, the invention can also be suitable for use with a plug connector of another type, in particular for use with a plug connector that has a single electric cable.

The electric cables 3, 3b shown are to be understood to be merely exemplary. In principle, the invention can be suitable for use with any electric cable, for example also for use with an electric cable with a plurality of inner conductors.

The electric cables 3a, 3b shown by way of example are prefabricated in each case at their front end 5 with an inner conductor contact element 6, which is electrically and mechanically connected to an inner conductor of the cables 3a, 3b. The inner conductor contact element 6 for example can be press fit or welded, in particular ultrasonically welded to the inner conductor of the cables 3a, 3b. As shown in the exemplary embodiments, the inner conductor contact element 6 can be received in an insulating housing 7, for example an insulating housing 7 consisting of two insulating shells. The cable 3a, 3b can also be prefabricated with a support sleeve 8, which is applied to the cable sheath of the cable 3a, 3b and/or the outer conductor of the cable 3a, 3b, in particular an outer conductor braid 10 (see FIG. 13). A crimp sleeve 11 can be slid onto the support sleeve 8 and crimped or press-fit with the support sleeve 8. The outer conductor braid 10, which was bent back towards the rear over the support sleeve 8 prior to the crimp sleeve 11 being applied, can run between the support sleeve 8 and the crimp sleeve 11.

Lastly, further plug connector components can also be slid on the cable sheath 9 of the cable 3a, 3b for the subsequent final assembly of the plug connector 2, for example a line seal 12 (not shown), a cable holding means 13 and a holding cap 14.

The cables 3a, 3b can be supplied to the device 1 by a transport unit (not shown in greater detail) or by a user. This process is shown in FIG. 1.

In particular while the cables are being supplied, it can be provided that a checking unit 15 checks a correct pre-processing, in particular the correct pre-equipping of the cable sheath 9 with the plug connector components 12, 13, 14. The checking unit 15 can be formed in particular as an optical checking unit 15, for example as a camera or light band. If the checking unit 15 determines an incorrect pre-processing of the cable 3a, 3b, in particular an insufficient pre-equipping of the cable 3, 3b, the assembly process for example can be interrupted and cable 3a, 3b rejected.

While the cables 3a, 3b are being introduced, these can be pushed into a feed unit 16 in a feed direction X. The feed unit 16 is used to press the front end 5 of the cable 3a, 3b into a corresponding plug-in point 17 in the housing assembly 4 of plug connector 2 and will be described in greater detail further below.

The cables 3a, 3b can preferably be acted on at a starting position PA preferably with the help of an alignment aid 18 and can be correctly aligned. The alignment aid 18 for this purpose has, for example, a stop 18a for the crimp sleeve 11.

The feed unit 16 has a holding unit 19 for fixing the cable 3a, 3b. The holding unit 19 in the exemplary embodiment shown in FIGS. 1 to 4 has two clamping jaws 20 movable towards the cable sheath 9 of the cable 3a, 3b. Once the cable 3a, 3b has been placed or supplied, the clamping jaws 20 can be closed accordingly or the cables 3a, 3b can be fixed by the holding unit 19.

It can then be provided that the feed unit 16 moves the cables 3a, 3b towards the housing assembly 4 in the feed direction X and presses them into the housing assembly.

In principle, the cables 3a, 3b can be processed or pressed in by the two feed units 16 in parallel or successively. The cables 3a, 3b are preferably pressed in successively in order to better control and monitor the pressing-in process. In principle, a common feed unit 16 or at least one common drive can therefore also be provided for the feed units 16. In the exemplary embodiment of FIGS. 1 to 4, the feed unit 16 has a rail system in order to move the holding unit 19 linearly along the feed direction X. In the exemplary embodiment shown in FIGS. 9 to 11, by contrast, a spindle drive is provided, which moves only one of the two holding devices 19 selectively.

Once the cable 3a, 3b has been fixed, the housing assembly 4 can be fixed initially in an assembly position by means of a fixing unit 21, prior to the cable 3a, 3b being pressed in. By way of example, two pressing jaws 22 for fixing the housing assembly 4 are shown.

The feed unit 16 can then press the front end 5 of the cable 3a, 3b into the corresponding plug-in point 17 in the housing assembly 4. During this process, the crimp sleeve 11 is preferably pressed into the plug-in point 17, resulting in the subsequent holding force of the cable 3a, 3b in the plug connector 2.

A force transducer 23 for detecting the pressing force applied while the cable 3a, 3b is being pressed in is provided. The force transducer 23 in the exemplary embodiment is part of the feed unit 16 and is indicated merely as a black box in FIG. 1. The feed unit 16 presses the front end 5 of the cable 3a, 3b into the housing assembly 4 until the inner conductor contact element 6 has reached a target position Ps within the housing assembly 4. An optical sensor unit 24 detects the actual position Pi of the inner conductor element 6 within the housing assembly 4 while the cable 3a, 3b is being pressed in.

A control unit 25 (likewise indicated merely as a black box in FIG. 1) for monitoring the assembly of the plug connector 2 can be provided, in particular for evaluating the detected actual position Pi and the detected pressing force within the scope of a quality control. The control unit 25 can evaluate the pressing force protected by the force transducer 23 while the cable is being pressed in and can compare this pressing force with a specification for the pressing force. If the pressing force does not correspond to the specification, the plug connector 2 for example can be marked accordingly and rejected as appropriate.

FIGS. 5 to 8 show the pressing of the cable 3a, 3b into the housing assembly 4 in a side view, wherein the housing assembly 4 is shown in section and in a significantly simplified manner.

The housing assembly 4 can have a spring-mounted detent means 26, in order to fix the inner conductor contact element 6. In order to simplify the assembly of the cable 3a, 3b in the plug connector 2, a prestressing unit 27 can be provided in order to initially mechanically prestress the detent means 26 within the housing assembly 4 orthogonally to the feed direction X. To this end, the prestressing unit 27 can have, for example, an extendable telescopic ram 28, which prestresses the detent means 26 from the displacement path of the inner conductor contact element 6, against a spring force. In order to release the displacement path again subsequently for the inner conductor contact element 6, the prestressing unit 27, upon contact with the inner conductor contact element 6 or in the event of imminent contact with the inner conductor contact element 6, can be removed from the displacement path. By way of example, a tactile element 29 is shown, which can be contacted by the inner conductor contact element 6 and thus triggers the retraction, for example also a mechanical snapping in, of the telescopic ram 28 (see FIGS. 6 and 7). The front end 5 of the cable 3a, 3b can then be pressed further into the housing assembly 4 until the inner conductor contact element 6 has reached its target position Ps in the housing assembly 4 (see FIG. 8).

FIGS. 9 to 11 show a preferred exemplary embodiment of the device 1 according to the invention. FIG. 9 shows the state while a first cable 3a is being placed in the device 1. FIG. 10 shows a state of the device 1 in which the cable 3a has been correctly aligned in the starting position PA by means of the alignment aid 18. In FIG. 11, the cable 3a has been fixed by an individual clamping jaw 20 of the holding unit 19 by the cable 3a being pressed by the clamping jaw 20 against a support 30. The housing assembly 4 in FIG. 11 is additionally fixed, for the subsequent pressing in, by a fixing unit 21 with an individual pressing jaw 22 in the manner of a plate having a negative of the housing assembly.

FIG. 12 shows the exemplary plug connector 2, shown in a schematic manner, during its final assembly process. Within the scope of the final assembly, once the cable 3a, 3b has been pressed in, it can be provided to assemble the further plug connector components 12, 13, 14. To this end, the line seal 12 can initially be pushed into the corresponding plug-in point 17 of the housing assembly 4 and fixed by the cable holding means 13. The holding cap 14 can then be applied from outside onto the plug-in point 17 and fixed.

The device 1 according to the invention can be part of a system 31 for assembly of the electrical plug connector 2. An exemplary system 31 is shown in FIG. 13. The system 31, besides the device 1, can also have at least one processing module 32 independent of the device 1 for fabricating the electric cable 3a, 3b or for assembly of the electrical plug connector 2.

A plurality of processing modules 32 are shown in FIG. 13. The individual processing modules 32 are arranged by way of example in groups 33, 34. By way of example, two groups 33, 34 of processing modules 32 are shown.

Within the scope of the system 31, for example processing modules 32 of a first group 33 can be designed for prefabrication of the electric cable 3a, 3b. Here, in particular processing modules 32 can be provided in order to trim the length of the cable 3a, 3b to a predefined length in order to strip the insulation from cable components (for example a region of the cable sheath 9) in order to process the outer conductor braid 10 of the cable 3a, 3b in order to apply one or more support sleeves 8 and/or crimp sleeves 11 in order to assemble the inner conductor contact element 6 and optionally the insulating housing 7.

The cables 3a, 3b prefabricated this way can then be transferred to the second group 34 of processing modules, wherein the device 1 according to the invention is shown by way of example as part of the second group 34. The cables 3a, 3b can therefore be pressed into the housing assembly 4 using the device 1 according to the invention, after which the final assembly in a further, subsequent processing module 32 can take place.

A workpiece carrier system 35 can be provided to transport the cables 3a, 3b. The cables 3a, 3b can thus be transported between the processing modules 32 or between the groups 33, 34 of processing modules 32.

A dedicated conveying unit 36 and a dedicated transport unit 37 is preferably provided for each group 33, 34 of processing modules 32 in order to move the one or more cables 3a, 3b and/or the processing modules 32 (and/or the tools of the processing modules 32) towards one another for the processing. The transport unit 37 can also serve to introduce the cable 3a, 3b into the device 1 according to the invention. The transport unit 37 can be part of the device 1 and/or part of the system 31.

A gripping unit 38 or another transport system can additionally be provided in order to transport the cables 3a, 3b between the various groups 33, 34 of processing modules 32.

In order to increase the throughput of the assembled plug connector 2 or reduce the process time, it can possibly be provided to provide the first group 33 of processing modules 32 for prefabrication of the electric cable 3a, 3b in duplicate in the system 31, in particular if the plug connector 2 is to be equipped with two cables 3a, 3b.

What is claimed is:

1. A device for assembly of an electrical plug connector comprising:
a) a feed unit which is designed to press a front end of an electric cable, said front end being prefabricated with an inner conductor contact element, in a feed direction into a corresponding plug-in point of a housing assembly of the plug connector until the inner conductor contact element has reached a target position within the housing assembly;
b) an optical sensor unit for detecting the actual position of the inner conductor contact element within the housing assembly while the cable is being pressed in; and
c) a force transducer for detecting the pressing force applied while the cable is being pressed in.

2. The device as claimed in claim 1, wherein the feed unit has a holding unit for fixing the cable while the cable is being pressed in, wherein the holding unit has at least one clamping jaw movable towards a cable sheath of the cable.

3. The device as claimed in claim 1, wherein a control unit for monitoring the assembly is provided, in particular for evaluating the detected actual position and the detected pressing force within the scope of a quality control.

4. The device as claimed in claim 1, wherein a fixing unit for fixing the housing assembly in an assembly position along the feed direction is provided.

5. The device as claimed in claim 1, wherein an alignment aid with a receptacle and/or with a stop for the front end of the cableis provided and designed to correctly align the cable in a starting position along the feed direction prior to the cable being pressed in.

6. The device as claimed in claim 1, wherein a checking unit is provided and designed to check a correct preprocessing of the cable while the cable is being placed in the device and/or while the cable is being pressed into the housing assembly.

7. The device as claimed in claim 1, wherein a prestressing unit is provided and designed to mechanically prestress a detent means, provided for latching the inner conductor contact element within the housing assembly orthogonally to the feed direction.

8. The device as claimed in claim 1, wherein the feed unit is designed to press a front end of a second electric cable, said front end being prefabricated with an inner conductor contact element in the feed direction into a corresponding second plug-in point of the housing assembly.

9. A method for assembling an electrical plug connector in accordance with which a front end of an electric cable, said front end being prefabricated with an inner conductor contact element, is pressed by a feed unit in a feed direction into a corresponding plug-in point of a housing assembly of the plug connector until the inner conductor contact element has reached a target position within the housing assembly, wherein an optical sensor unit detects the actual position of the inner conductor contact element within the housing assembly while the cable is being pressed in, and wherein a force transducer detects the pressing force applied while the cable is being pressed in.

10. The method as claimed in claim 9, wherein prior to the cable being pressed into the housing assembly, a correct preprocessing of the cable is checked by a checking unit.

11. The method as claimed in claim 9, wherein the front end of the cable, prior to the cable being pressed into the housing assembly, is firstly correctly aligned in a starting position in the feed direction by introducing the front end of the cable at least in part into a receptacle of an alignment aid and/or contacting said front end of the cable against a stop of the alignment aid.

12. The method as claimed in claim 11, wherein the alignment aid, once the front end of the cable has been correctly aligned, is removed from the displacement path of the cable.

13. The method as claimed in claim 9, wherein the housing assembly is fixed in an assembly position by a fixing unit prior to the cable, being pressed into the housing assembly.

14. The method as claimed in claim 9, wherein a prestressing unitmechanically prestresses a detent means, provided for latching the inner conductor contact element within the housing assembly, in the housing assembly orthogonally to the feed direction.

15. The method as claimed in 14, wherein the prestressing unit prestresses the detent means as a result of a telescopic ram being extended.

16. The method as claimed in claim 14, wherein the prestressing unit is removed from the displacement path of the inner conductor contact element in the event of contact with the inner conductor contact element of the electric cable.

17. The method as claimed in claim 9, wherein the feed unit stops the feed of the cable as soon as the actual position of the inner conductor contact element detected by the optical sensor unit corresponds to the target position.

18. The method as claimed in claim 9, wherein a control unit evaluates the pressing force detected by the force transducer while the cable is being pressed into the housing assembly and compares the pressing force with a specification for the pressing force in order to classify the cable within the scope of a quality control.

19. The method as claimed in claim 9, wherein once the target position of the inner conductor contact element of the cable has been reached, a front end of a second electric cable, said front end being prefabricated with an inner conductor contact element, is pressed in the feed direction into a corresponding second plug-in point of the housing assembly.

20. (canceled)

21. A system for assembly of an electrical plug connector, comprising:
a) a device for assembly of the plug connector, having a feed unit which is designed to press a front end of an electric cable, said front being prefabricated with an inner conductor contact element, in a feed direction into a corresponding plug-in point of a housing assembly of the plug connector until the inner conductor contact element has reached a target position within the housing assembly, an optical sensor unit for detecting the actual position of the inner conductor contact element within the housing assembly while the cable is being pressed in, and a force transducer for detecting the pressing force applied while the cable is being pressed in;
b) at least one processing module, independent of the device, for processing the electric cable.

22. (canceled)
